(19) United States
(12) Patent Application Publication
(10) Pub. No.: US 2026/0203752 A1
(43) Pub. Date: Jul. 16, 2026

(54) System and Method for a Network Authentication With Device Level Authentication Controls

(71) Applicant: Visa International Service Association, San Francisco, CA (US)

(72) Inventors: Sandeep Tharoor, Anjumoorthy (IN); Yashaswini Shetty, Bangalore (IN); Kaushal Kumar Jha, Mumbai (IN); Anandan Ethirkottai Sundararajan, Karnataka (IN); Rajagopal Prabhakar, Mumbai (IN)

(21) Appl. No.: 19/138,214

(22) PCT Filed: Dec. 12, 2023
(86) PCT No.: PCT/US2023/083491

§ 371 Date: Jun. 12, 2025

(30) Foreign Application Priority Data
Dec. 13, 2022 (IN) 202241072014

(51) Int. Cl. G06Q 20/38; G06Q 20/40; H04L 9/08; H04L 9/32

(52) U.S. Cl. CPC G06Q 20/3829; G06Q 20/3825; G06Q 20/4014; G06Q 20/4016; G06Q 20/409; H04L 9/0825; H04L 9/3247; H04L 2209/56

(57) ABSTRACT

A system and method for network authentication using device level authentication controls. The method comprises receiving a first payment transaction request from a user device. The method comprises, enabling the authentication mode for the user to perform an authentication using the selected authentication mode and generating a key pair for linking with the enabled authentication mode for further authentication of the user device in one or more further transaction requests. The method further comprises generating an enrolment completion message and executing the first payment transaction request upon successful signing using the linked key pair. In this manner, the present disclosure may be configured to utilize device authentication data as a part of network authentication risk checks leading to providing a more secure way of completing a transaction.

### CROSS-REFERENCE TO RELATED APPLICATIONS

This application is the United States national phase of International Application No. PCT/US23/83491, filed on Dec. 12, 2023, and claims priority to Indian Provisional Patent Application No. 202241072014, filed on Dec. 13, 2022, the disclosures of which are hereby incorporated by reference in their entireties.

### BACKGROUND

### 1. Technical Field

The present disclosure relates, in general, to field of digital transactions. Particularly, the present disclosure relates to a system and method for network authentication using device level authentication controls.

### 2. Technical Considerations

In recent years, there may have been drastic increase of e-commerce transactions card-on-file payments, Unified Payment Interface (UPI), network banking and the like using user devices. In such transactions, there is involvement of a PIN which needs to be entered by the user and the user have to wait for a One Time Password (OTP) to successfully complete a transaction. However, this aforementioned implementation is time consuming as receiving the OTP may be delayed due to network issues, server issues and the like. In order to solve this aforementioned problem, an implementation based on regulatory dispensation has emerged where payment networks may be allowed to perform authentication for the transaction on-behalf of issuer or the payment networks. In such implementations, an authentication solution was introduced which relies on device integrity and identity as a primary factor for authenticating the transaction resulting in reduction in friction during the transactions. With such implementations though friction and lack of scalability was reduced, risk aver users were hesitant to trust a payment flow without second factor authentication were not keen on performing such payments. This led to reduction in the number of users availing such services of network authentication.

Furthermore, with such implementations since the transactions may be implemented by payment networks, if such server associated with the payment networks fails due to server issues, the payment network may not be able to successfully complete the transaction. Furthermore, if there is no security mechanism or an authentication system of the payment network, or an authentication system, then this may result in unsuccessful verification of cardholder initiating the transaction and hence, may lead to potential fraud. Therefore, there is a need for an improved method for network authentication using device level authentication controls.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

One or more shortcomings of the existing system may be overcome, and additional advantages may be provided through the present disclosure. Additional features and advantages may be realized through the techniques of the present disclosure. Other non-limiting embodiments and aspects of the disclosure are described in detail herein and are considered a part of the present disclosure.

Accordingly, provided are improved systems, methods, and computer program products for network authentication with device level authentication controls.

Disclosed herein is a method for network authentication using device level authentication controls. The method comprises receiving, by an authentication system, a first payment transaction request from a user device. The first payment transaction request includes a consent to register a user of the user device to authenticate based on an authentication mode selected by the user. Furthermore, in response to receiving the consent, the method comprises enabling the authentication mode, by the authentication system, for the user to perform an authentication using the selected authentication mode. Upon successful authentication, the method comprises generating, by the authentication system, a key pair for linking with the enabled authentication mode for further authentication of the user device in one or more further transaction requests. Furthermore, the method comprises generating, by the authentication system, an enrolment completion message enabling the user device to be authenticated in the one or more further transaction requests using the enrolled authentication mode. Thereafter, the method comprises executing, by the authentication system, the first payment transaction request upon successful signing using the linked key pair.

Further, disclosed herein is an authentication system for network authentication using device level authentication controls. The authentication system comprises a processor and memory communicatively coupled to the processor. The memory stores instructions, which, on execution, cause the processor to receive a first payment transaction request from a user device. The first payment transaction request includes a consent to register a user of the user device to authenticate based on an authentication mode selected by the user. Furthermore, in response to receiving the consent, the processor is configured to enable for the user to perform an authentication using the selected authentication mode. Furthermore, upon successful authentication, the processor is configured to generate an enrolment completion message enabling the user device to be authenticated in the one or more further transaction requests using the enrolled authentication mode. Thereafter, the processor is configured to execute the first payment transaction request upon successful signing using the linked key pair.

Furthermore, the present disclosure discloses a method for network authentication using device level authentication controls. The method comprises receiving, by an authentication system, a second payment transaction request from a user device and an authentication mode as an input from a user. Furthermore, the method comprises verifying, by the authentication system, user authentication based on comparison of an input authentication mode and a pre-registered authentication mode set by the user. Furthermore, upon successful verification of the user, the method comprises signing, by the authentication system, one or more transaction elements associated with the second payment transaction request using a key pair linked with the pre-registered authentication mode. Thereafter, the method comprises executing, by the authentication system, the second payment transaction request upon successful signing using the linked key pair.

Still, the present disclosure discloses an authentication system for network level authentication using device level authentication controls. The authentication system comprises a processor and a memory. The memory is communicatively coupled to the processor. The memory stores instructions which on execution causes the processor to receive a second payment transaction request from a user device and an authentication mode as an input from a user. Furthermore, the processor is configured to verify user authentication based on comparison of an input authentication mode and a pre-registered authentication mode set by the user. Furthermore, upon successful verification of the user, the processor is configured to sign one or more transaction elements associated with the second payment transaction request using a key pair linked with the pre-registered authentication mode. Thereafter, the processor is configured to execute the second payment transaction request upon successful signing using the linked key pair.

The foregoing summary is illustrative only and is not intended to be in any way limiting. In addition to the illustrative aspects, embodiments, and features described above, further aspects, embodiments, and features will become apparent by reference to the drawings and the following detailed description.

Further non-limiting embodiments or aspects are set forth in the following numbered clauses:

Clause 1: A method comprising: receiving, by an authentication system, a first payment transaction request from a user device, wherein the first payment transaction request includes a consent to register a user of the user device to authenticate based on an authentication mode selected by the user; in response to receiving the consent, enabling the authentication mode, by the authentication system, for the user to perform an authentication using the selected authentication mode; upon successful authentication, generating, by the authentication system, a key pair for linking with the enabled authentication mode for further authentication of the user device in one or more further transaction requests; generating, by the authentication system, an enrolment completion message enabling the user device to be authenticated in the one or more further transaction requests using the enrolled authentication mode; and executing, by the authentication system, the first payment transaction request upon successful signing using the linked key pair.

Clause 2: The method of clause 1, wherein the enabled authentication mode is one of a first plurality of registered authentication modes enrolled by the user, wherein the first plurality of registered authentication modes are associated with device level authentication controls.

Clause 3: The method of clause 1 or 2, wherein the key pair comprises a private key and a public key, wherein the private key is used for signing one or more transactions originating from the user device and stored in the user device, wherein the public key is used for validating the signed transactions originating from the user device and stored in the authentication system.

Clause 4: The method of any of clauses 1-3, wherein executing the first payment transaction request comprising: determining device integrity of the user device; accessing the key pair in response to successful device integrity determination of the user device; and validating the first payment transaction request to proceed with payment of the first payment transaction request.

Clause 5: The method of any of clauses 1-4, comprising storing in a database, the authentication mode registered by the user, the authentication mode selected by the user, success or failure of device authentication, and timestamp associated with the success or failure of the device authentication.

Clause 6: The method of any of clauses 1-5, comprising: determining as to whether the user device is associated with device level authentication controls; and enrolling one of a second plurality of authentication modes to authenticate the one or more further transaction requests, in response to determination that the user device is not associated with the device level authentication controls.

Clause 7: A method comprising: receiving, by an authentication system, a second payment transaction request from a user device and an authentication mode as an input from a user; verifying, by the authentication system, user authentication based on comparison of an input authentication mode and a pre-registered authentication mode set by the user; upon successful verification of the user, signing, by the authentication system, one or more transaction elements associated with the second payment transaction request using a key pair linked with the pre-registered authentication mode; and executing, by the authentication system, the second payment transaction request upon successful signing using the linked key pair.

Clause 8: The method of clause 7, wherein the key pair is accessed in response to successful device integrity determination of the user device.

Clause 9: The method of clauses 7 or 8, wherein execution of the second payment transaction request comprises: determining integrity of the user device; and storing in a database, user device authentication data including the authentication mode pre-registered by the user, the authentication mode selected by the user, success or failure of device authentication, and timestamp associated with the success or failure of the device authentication.

Clause 10: The method of any of clauses 7-9, wherein for determining the integrity of the user device the method further comprises determining one or more risks associated with the user device based on stored user device authentication data in the database.

Clause 11: An authentication system comprising: a processor; a memory, communicatively coupled to the processor, wherein the memory stores instructions, which, on execution, cause the processor to: receive a first payment transaction request from a user device, wherein the first payment transaction request includes a consent to register a user of the user device to authenticate based on an authentication mode selected by the user; in response to receiving the consent, enable the authentication mode for the user to perform an authentication using the selected authentication mode; upon successful authentication generate a key pair for linking with the enabled authentication mode for further authentication of the user device in one or more further transaction requests; generate an enrolment completion message enabling the user device to be authenticated in the one or more further transaction requests using the enrolled authentication mode; and execute the first payment transaction request upon successful signing using the linked key pair.

Clause 12: The authentication system of clause 11, wherein the enabled authentication mode is one of a first plurality of registered authentication modes enrolled by the user, wherein the first plurality of registered authentication modes are associated with device level authentication controls.

Clause 13: The authentication system of clauses 11 or 12, wherein the key pair comprises a private key and a public key, wherein the private key is used for signing one or more transactions originating from the user device and stored in the user device, wherein the public key is used for validating the signed transactions originating from the user device and stored in the authentication system.

Clause 14: The authentication system of any of clauses 11-13, wherein for executing the first payment transaction request the processor is configured to: determine device integrity of the user device; access the key pair in response to successful device integrity determination of the user device; and validate the first payment transaction request to proceed with payment of the first payment transaction request.

Clause 15: The authentication system of any of clauses 11-14, wherein the processor is configured to store in a database, the authentication mode registered by the user, the authentication mode selected by the user, success or failure of device authentication, and timestamp associated with the success or failure of the device authentication.

Clause 16: The authentication system of any of clauses 11-15, wherein the processor is configured to: determine as to whether the user device is associated with device level authentication controls; and enroll one of a second plurality of authentication modes to authenticate the one or more further transaction requests, in response to determination that the user device is not associated with the device level authentication controls.

Clause 17: An authentication system comprising: a processor; a memory, communicatively coupled to the processor, wherein the memory stores instructions, which, on execution, cause the processor to: receive a second payment transaction request from a user device and an authentication mode as an input from a user; verify user authentication based on comparison of an input authentication mode and a pre-registered authentication mode set by the user; upon successful verification of the user, sign one or more transaction elements associated with the second payment transaction request using a key pair linked with the pre-registered authentication mode; and execute the second payment transaction request upon successful signing using the linked key pair.

Clause 18: The authentication system of clause 17, wherein the key pair is accessed in response to successful device integrity determination of the user device.

Clause 19: The authentication system of clauses 17 or 18, wherein for execution of the second payment transaction request the processor is configured to: determine integrity of the user device; and store in a database, user device authentication data including the authentication mode pre-registered by the user, the authentication mode selected by the user, success or failure of device authentication, and timestamp associated with the success or failure of the device authentication.

Clause 20: The authentication system of any of clauses 17-19, wherein for determining the integrity of the user device the processor is further configured to determine one or more risks associated with the user device based on stored user device authentication data in the database.

### BRIEF DESCRIPTION OF THE DRAWINGS

The accompanying drawings, which are incorporated in and constitute a part of this disclosure, illustrate exemplary embodiments or aspects and, together with the description, explain the disclosed principles. In the figures, the left-most digit(s) of a reference number identifies the figure in which the reference number first appears. The same numbers are used throughout the figures to reference like features and components. Some non-limiting embodiments or aspects of system and/or methods in accordance with the present subject matter are now described, by way of example only, and regarding the accompanying figures, in which:

FIG. 1 is a schematic representation depicting an environment for network authentication using device level authentication controls, in accordance with some non-limiting embodiments or aspects of the present disclosure;

FIG. 2 is a detailed block diagram of an authentication system for network authentication using device level authentication controls, in accordance with some non-limiting embodiments or aspects related to the present disclosure;

FIG. 3A is a flowchart illustrating a method for network authentication using device level authentication controls, in accordance with some non-limiting embodiments or aspects of the present disclosure;

FIG. 3B is a flowchart illustrating a method of enabling network authentication using device level authentication controls, in accordance with some non-limiting embodiments or aspects of the present disclosure; and

FIG. 4 is a block diagram of an exemplary computer system for implementing non-limiting embodiments or aspects in accordance with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments or aspects as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first device, a first server, or a first processor that is recited as performing a first step or a first function may refer to the same or different device, server, or processor recited as performing a second step or a second function.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments or aspects.

While the disclosure is susceptible to various modifications and alternative forms, specific embodiment thereof has been shown by way of example in the drawings and will be described in detail below. It should be understood, however, that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the non-limiting embodiments or aspects of the disclosure, reference is made to the accompanying drawings that form a part hereof, and in which are shown by way of illustration specific embodiments in which the disclosure may be practiced. These non-limiting embodiments or aspects are described in sufficient detail to enable those skilled in the art to practice the disclosure, and it is to be understood that other non-limiting embodiments or aspects may be utilized and that changes may be made without departing from the scope of the present disclosure. The following description is, therefore, not to be taken in a limiting sense.

In recent years, there has been drastic increase of digital transactions such as e-commerce transactions, card-on-file payments, Unified, Payment Interface (UPI), network banking and the like using user devices. However, the issue with the aforementioned transaction process is that these transaction processes are time consuming as sometimes due to network issues, issuer servers may be down due to which OTP may not be generated, and this might lead to unsuccessful transaction. In order to solve the aforementioned issues, one of the implementations based on regulatory dispensation, payment networks may be allowed to perform authentication for the transaction on-behalf of issuer.

However, though friction is reduced, and lack of scalability is reduced with such aforementioned conventional solutions, risk averse users who are hesitant to trust a payment flow without second factor authentication are not keen on performing such payments leading to reduction in the number of users availing such services of network authentication. Furthermore, with such implementations since the transactions may be implemented by payment networks, if such server associated with the payment networks fails due to server issues, the payment network may not be able to successfully complete the transaction. Furthermore, if there is no security mechanism or an authentication system, then this may result in unsuccessful verification of cardholder initiating the transaction and hence, may lead to potential fraud.

In order to solve the aforementioned problem, the present disclosure relates to a method for network authentication using device level authentication controls. The method comprises receiving, by an authentication system, a first payment transaction request from a user device. Further, in response to receiving the consent, the method comprises enabling the authentication mode for the user to perform an authentication using the selected authentication mode. Furthermore, the method comprises generating a key pair for linking with the enabled authentication mode for further authentication of the user device in one or more further transaction requests and generating an enrolment completion message enabling the user device to be authenticated in the one or more further transaction requests using the enrolled authentication mode. Thereafter, the method comprises executing the first payment transaction request upon successful signing using the linked key pair. Hence, the present disclosure may be configured to utilize device authentication data as a part of network authentication risk checks and the associated cryptographic techniques that are utilized as a part of device integrity determination, leading to providing a more secure way of completing a transaction. This secure way of transaction as disclosed in the method ensures and checks if the registered user is performing the network authentication or not, resulting in providing a secured transaction for the user during such network authentication using device level authentication controls. As an additional advantage, the present disclosure may provide enhanced secure way of authenticating several users utilizing the network authentication using device level authentication controls due to utilization of the network authentication risk checks in the device level authentication controls.

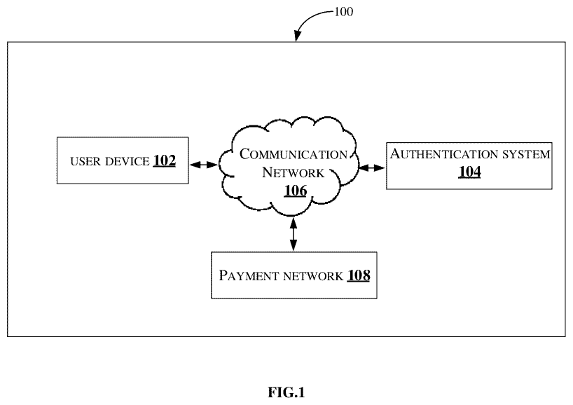

FIG. 1 depicts a schematic representation depicting an environment (100) for network authentication using device level authentication controls, in accordance with some non-limiting embodiments or aspects of the present disclosure.

The environment (100) includes a user device (102), an authentication system (104) and a payment network (108) which are communicatively coupled to a communication network (106) and the like. The communication network (106) may be one of, a wired communication network, a wireless communication network or a combination of both wired and wireless communication network. The communication network (106) may comprise the user devices (102) connected with each other via one or more network devices such as switch, hub, gateway, router and the like. The user device (102) associated with a user may be configured to send payment transaction requests to the payment network (108) for authentication of a transaction based on an authentication mode selected by the user. In some non-limiting embodiments or aspects, the payment transaction requests may also be referred to as one or more transaction requests.

The authentication system (104) may be configured to perform the network authentication using the device level authentication controls for one or more transaction requests. In some non-limiting embodiments or aspects, the authentication system (104) receives a first payment transaction request from the user device (102). The first payment transaction request may include a consent to register a user of the user device (102) to authenticate the transaction based on the authentication mode selected by the user. The authentication mode may be one of a first plurality of registered authentication modes enrolled by the user. The first plurality of registered authentication modes enrolled by the user are associated with the device level authentication controls. For example, if the authentication mode for unlocking the user device (102) associated with the user is a password, then the first plurality of registered authentication mode is password based authentication wherein the user can be authenticated upon entering the same password. If the authentication system (104) determines that the user did not consent to register any of the authentication mode for authenticating the transaction and that the user device (102) is not associated with the device level authentication controls, then the authentication system (104) may enroll the user of the user device (102) to one of a second plurality of authentication modes to authenticate one or more further transaction requests. For example, the authentication system (104) provides the user an option of setting a new authentication mode for example, a 4-digit PIN, as a device level authentication for one or more further transactions.

Upon registering or enabling a first plurality of authentication modes for the user associated with the user device (102), the authentication system (104) may associate the first plurality of authentication mode with the user device (102). In some non-limiting embodiments or aspects, the authentication system may generate a key pair and may link the generated key pair with the enabled authentication mode for further authentication of the user device (102) in the one or more further transaction requests. The key pair may include, but not limited to a private key and a public key. The private key may be used for signing one or more transactions originating from the user device (102). The public key may be utilized for validating the signed transactions originating from the user device (102) and is stored in the authentication system (104).

Upon linking the first plurality of authentication modes of the user with the key pair, the authentication system (104) may generate an enrolment completion message enabling the user device (102) to be authenticated in the one or more further transaction requests using the enrolled authentication mode and may execute the first payment transaction request.

In some non-limiting embodiments or aspects, the authentication system (104) is configured to execute the first payment transaction request, upon verifying the integrity of the user device (102). For example, the authentication system (104) may determine device integrity of the user device (102) and upon successfully determining the device integrity of the user device (102), the authentication system (104) may validate the first payment transaction request by accessing the key pair. The validation of the key pair is done using cryptography techniques. In some non-limiting embodiments or aspects, the payment network (108) may validate the signature of the linked key pair. In some non-limiting embodiments or aspects, if the authentication system (104) determines that the integrity of the user device (102) is compromised, the authentication system (104) may not execute the first payment transaction and generate a transaction failure message prompting the user about the unsuccessful transaction.

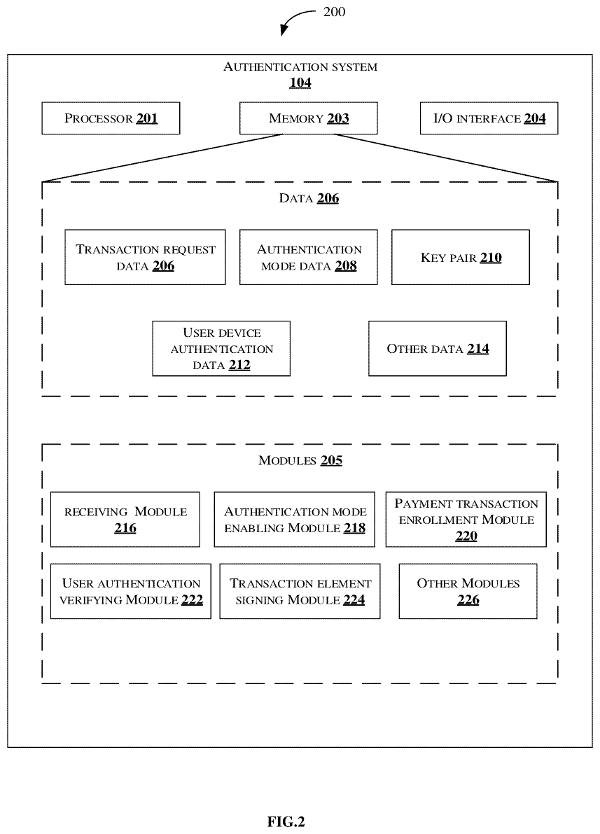

In some non-limiting embodiments or aspects, the authentication system (104) may receive a second payment transaction request and the associated input authentication mode from the user device (102) associated with the user. Furthermore, for verifying the user device (102) associated with the user, the authentication system (104) may verify the input authentication mode from the user device (102) with a pre-registered authentication mode. The pre-registered authentication mode may be set by the user at the time of the registering for the authentication of the one or more further transaction requests based on the authentication mode selected by the user. Upon successful verification of the user device (102) associated with the user, the authentication system (104) may sign one or more transaction elements of the second payment transaction request using the key pair linked with the pre-registered authentication mode. In some non-limiting embodiments or aspects, the key pair generated may be utilized to cryptographically sign the one or more transactions in a tokenized transaction or in cases when a transaction number is in a flow such as, but not limited to, a 3DS2.0 flow. Thereafter, the authentication system (104) may execute the second payment transaction request upon successful signing using the linked key pair. In some non-limiting embodiments or aspects, upon successful device integrity determination of the user device (102) associated with the user, the authentication system (104) may access the key pair. The authentication system (104) may determine the integrity of the user device (102) associated with the user based on one or more risks associated with the user device (102) and stored user device authentication data in the database. The user device authentication data may include, but not limited to, the authentication mode pre-registered by the user, the authentication mode selected by the user (also referred as the input authentication mode), success or failure state of device authentication, and timestamp associated with the success or failure state of the device authentication. For example, the authentication mode pre-registered by the user is a password for a user device A, a face ID for a user device B and the like. The success or failure of device authentication is indicative of total number of successful or failure attempts achieved using the authentication mode performed by the user on the user device (102) for authenticating one or more transaction requests. The timestamp associated with the success or failure of the device authentication may be for example, at 12:45 A.M. a failure of device authentication occurred after four attempts, at 01:45 P.M. successful device authentication occurred after three attempts and the like. This provides an inference that even after four attempts, the authentication mode entered by the user was incorrect leading to failure of the device authentication of a transaction request and the correct authentication mode was entered after two attempt that lead to successful device authentication of the one or more transaction requests. Detailed explanation of the network authentication using the device level authentication controls is shown in FIG. 2.

FIG. 2 depicts a detailed block diagram (200) of an authentication system (104) for network authentication using device level authentication controls, in accordance with some non-limiting embodiments or aspects related to the present disclosure.

In some non-limiting embodiments or aspects, the authentication system (104) may include a processor (201), a memory (203) and an I/O interface (204). The I/O interface (204) may be configured for receiving and transmitting an input signal or/and an output signal related to one or more operations of the authentication system (104). The memory (203) may be communicatively coupled to the processor (201) and one or more modules (205). The processor (201) may be configured to perform one or more functions of the authentication system (104) using data (206) and the one or more modules (205).

In an embodiment, the data (206) stored in the memory (203) may include, without limiting to, a transaction request data, an authentication mode data (208), a key pair (210), a user device authentication data (212) and other data (214). In some implementations, the data (206) may be stored within the memory (203) in the form of various data structures. Additionally, the data (206) may be organized using data models. The other data (214) may include various temporary data and files generated by the different components of the authentication system (104).

In some non-limiting embodiments or aspects, the transaction request data may include one or more transaction requests. The one or more transaction requests may include, but not limited to, a first payment transaction request, a second payment transaction request and the like. In some non-limiting embodiments or aspects, the one or more transaction requests includes a request to perform the network authentication using device level authentication controls using an authentication mode selected by a user. The first payment transaction request may include a consent to register the user device (102) to authenticate based on the authentication mode selected by the user. For example, if the user has chosen a password as the authentication mode during the first transaction, then for one or more further transactions, the same password should be entered by the user for successful completion of one or more further transactions. The second payment transaction request includes a request to perform the second payment transaction based on the network authentication using the device level authentication controls. For example, if the registration for performing the network authentication using the device level authentication controls was done using a password A, then the second payment transaction is successful only upon entering the same password A.

In some non-limiting embodiments or aspects, the authentication mode data (208) may include plurality of authentication modes registered by the user for performing the network authentication using the device level authentication controls. For example, the authentication modes may include, but not limited to, a static pin, a pattern, a password, a biometric authentication and the like. The authentication mode may be one of a first plurality of authentication modes registered by the user, second plurality of authentication modes registered by the user and the like. The first plurality of registered authentication modes are associated with device level authentication controls. For example, if a user has set a password X for unlocking the user device (102) associated with the user, then the password X has to be entered while authenticating an authentication. The second plurality of registered authentication modes are the authentication modes that the user selects if the user has not registered or not provided the consent to use the authentication mode to authenticate the transaction request.

In some non-limiting embodiments or aspects, the key pair (210) may be used to verify a second plurality of transactions associated with the second payment transaction request. The key pair (210) may include a private key and a public key that are linked with each other to be used for validating the second plurality of transactions. The private key is used for signing the second plurality of transactions originating from the user device (102) and stored in the user device (102). The public key is used for validating the signed transactions originating from the user device (102) and stored in the authentication system (104). Upon successful device integrity determination of the user device (102), the authentication system (104) may access the keypair. Furthermore, in some non-limiting embodiments or aspects, upon successful signing using the linked key pair, the authentication system (104) may execute one or more transaction requests. In some non-limiting embodiments or aspects, the payment network (108) may validate the signature of the linked key pair. In some non-limiting embodiments or aspects, the authentication system (104) may validate the signature of the linked key pair. The validation signature of the linked key pair may be performed using state of the cryptography techniques.

The user device authentication data (212) is a type of data utilized for determining integrity of the user device (102). The user device authentication data (212) may include, but not limited to, the authentication mode pre-registered by the user, the authentication mode selected by the user (also referred as input authentication mode), success or failure of device authentication, and a timestamp associated with the success or failure of the device authentication. Examples of the user device authentication data (212) is shown in the FIG. 1. The user device authentication data (212) may be stored in the database associated with the authentication system (104).

In some non-limiting embodiments or aspects, the data (206) may be processed by the one or more modules (205) of the authentication system (104). In an implementation, the one or more modules (205) may include, without limiting to, a receiving module (216), an authentication mode enabling module (218), a payment transaction enrollment module (220), a user authentication verifying module (222), a transaction element signing module (224) and other modules (226). In an embodiment, the other modules (226) may be used to perform various miscellaneous functionalities of the authentication system (104). It will be appreciated that such one or more modules (205) may be represented as a single module or a combination of different modules.

In some non-limiting embodiments or aspects, the receiving module (216) may be configured to receive the first payment transaction request from the user device (102). Upon registering the user device (102) for the network authentication to authenticate based on the authentication mode selected by the user, the authentication mode enabling module (218) may be configured to enable the user device (102) associated with the user to perform an authentication using the selected authentication mode. Upon successful authentication of the user device (102) associated with the user, the payment transaction enrollment module (220) may be configured to generate an enrolment completion message that enables the user device (102) to be authenticated in one or more further transactions requests using the enrolled authentication mode. In some non-limiting embodiments or aspects, the payment transaction enrollment module (220) may be configured to execute the first payment transaction request by determining device integrity of the user device (102), accessing the key pair (210) in response to successful device integrity determination of the user device (102) and validating the first payment transaction request.

Upon successful authentication of the first payment transaction request, in some non-limiting embodiments or aspects, the receiving module (216) may be configured to receive a second payment transaction request from the user device (102) and the input authentication mode as an input from a user. The user authentication verifying module (222) may be configured to verify the user authentication by comparing the input authentication mode with the pre-registered authentication mode set by the user.

Upon successful verification of the user device (102) associated with the user, the transaction element signing module (224) may be configured to sign one or more transaction elements associated with the second payment transaction request using the key pair (210) linked with the pre-registered authentication mode. Thereafter, upon successful signing using the linked key pair, the payment transaction enrollment module (220) may be configured to execute the second payment transaction request by determining the integrity of the user device (102) and storing the user device authentication data (212). For determining the integrity of the user device (102), the payment transaction enrollment module (220) may be configured to determine one or more risks associated with the user device (102) based on the user device authentication data (212). In some non-limiting embodiments or aspects, the one or more risks associated with the user device (102) may be for example, the payment transaction enrollment module (220) checking if the user device (102) has any vulnerabilities or misconfigurations based on information received from third party applications installed in the user device (102) such as antivirus or malware applications, device configuration applications and the like as part of determining the integrity of the user device (102).

In an alternate embodiment, the process of transaction performed by a payment network (108) and a merchant application (not shown) is explained in the forthcoming paragraphs. Firstly, the merchant application receives a payment transaction request along with the authentication mode as an input from the user device (102) associated with the user. The payment transaction request may include, but not limited to, a unique identifier, user device authentication data (212) stored in a merchant's wallet. Further, the merchant collects the device authentication result and the authentication mode, sends it to the payment network along with the transaction details as part of authentication request. If the input authentication mode is same as that of pre-registered authentication, then the merchant application sends the payment transaction request along with the input authentication mode shared by the user to the payment network (108). Further, the payment network (108) checks if the authentication mode enrolled by the user device (102) as part of the network authentication with device authentication controls. Thereafter, the payment network (108) sends an issuer device authentication identifier and a shared secret to the merchant application. In some non-limiting embodiments or aspects, the issuer device authentication identifier may be a key associated with the key pair (210) generated and stored in the user device (102). Further, the merchant application sends a request for the user to authenticate the transaction using the same device level authentication as that of the issuer device authentication identifier. On successful authentication, the merchant application retrieves the key pair (210) using the issuer device authentication identifier and signs the shared secret using the key pair (210). In some non-limiting embodiments or aspects, the shared secret is a random string generated (also referred as dynamic text) for the transaction dynamically. The shared secret is received by the merchant application. In some non-limiting embodiments or aspects, if the merchant application successfully signs the random string based on the shared secret provided by the payment network (108), it is inferred that the user has authenticated on the merchant application and the keypair is accessed based on the signature with respect to the random string by the merchant application. Further, the merchant application sends the signed secret to the payment network (108) using the keypair. Finally, the payment network (108) performs authentication checks using the data collected during the network authentication using the device authentication response, signed shared secret in addition to the network specific risk rule checks.

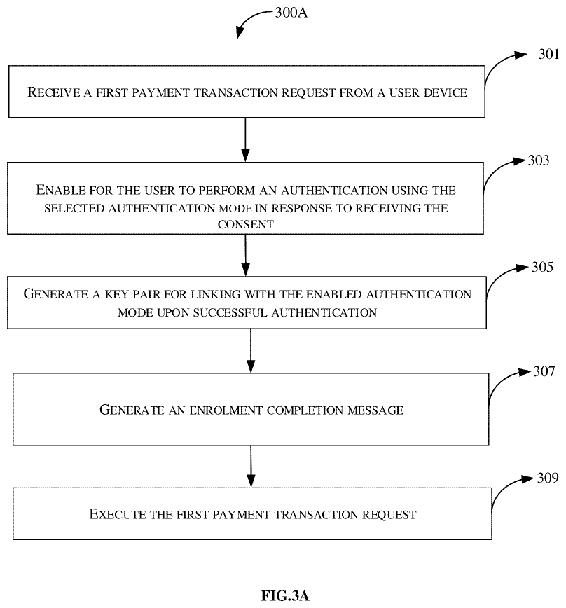

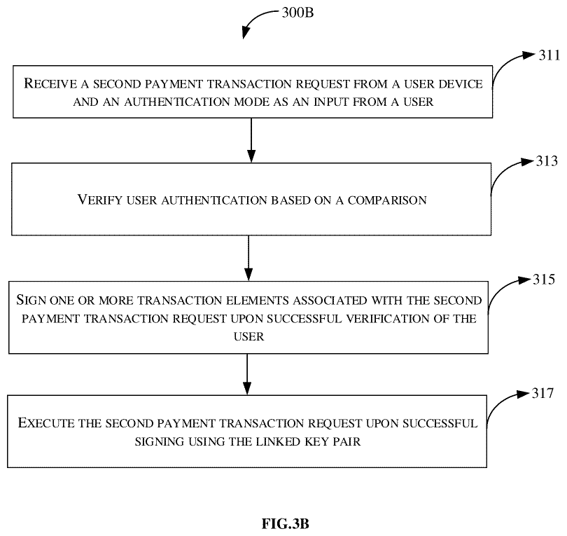

FIG. 3A depicts a flowchart illustrating a method (300A) for network authentication using device level authentication controls, in accordance with some non-limiting embodiments or aspects of the present disclosure.

As illustrated in the FIG. 3A, the method (300A) includes one or more blocks illustrating the method (300A) for network authentication for device level authentication controls. The method (300A) may be described in the general context of computer executable instructions. Generally, computer executable instructions can include routines, programs, objects, components, data structures, procedures, modules, and functions, which perform functions or implement abstract data types.

The order in which the method (300A) is described is not intended to be construed as a limitation, and any number of the described method blocks can be combined in any order to implement the method (300A). Additionally, individual blocks may be deleted from the methods without departing from the spirit and scope of the subject matter described herein. Furthermore, the method (300A) can be implemented in any suitable hardware, firmware, or a combination hardware and software.

At block 301, the method (300A) includes receiving, by an authentication system (104), a first payment transaction request from a user device (102). The first payment transaction request includes a consent to register a user of the user device (102) to authenticate based on an authentication mode selected by the user.

At block 303, in response to receiving the consent, the method (300A) includes enabling the authentication mode, by the authentication system (104), for the user to perform an authentication using the selected authentication mode.

At block 305, upon successful authentication, the method (300A) includes generating, by the authentication system (104), a key pair (210) for linking with the enabled authentication mode for further authentication of the user device (102) in one or more further transaction requests.

At block 307, the method (300A) includes generating, by the authentication system (104), an enrolment completion message enabling the user device (102) to be authenticated in the one or more further transaction requests using the enrolled authentication mode.

At block 309, upon successful signing using the linked key pair, the method (300A) includes executing, by the authentication system (104), the first payment transaction request.

FIG. 3B depicts a flowchart illustrating a method (300B) of enabling network authentication using device level authentication controls, in accordance with some non-limiting embodiments or aspects of the present disclosure.

As illustrated in FIG. 3B, the method (300B) includes one or more blocks illustrating a method (300B) for network authentication using device level authentication controls. The method (300B) may be described in the general context of computer executable instructions. Generally, computer executable instructions can include routines, programs, objects, components, data structures, procedures, modules, and functions, which perform functions or implement abstract data types.

The order in which the method (300B) is described is not intended to be construed as a limitation, and any number of the described method blocks can be combined in any order to implement the method (300B). Additionally, individual blocks may be deleted from the methods without departing from the spirit and scope of the subject matter described herein. Furthermore, the method (300B) can be implemented in any suitable hardware, firmware, or a combination of hardware and software.

At block 311, the method (300B) includes receiving, by an authentication system (104), a second payment transaction request from a user device (102) and an authentication mode as an input from a user.

At block 313, the method (300B) includes verifying, by the authentication system (104), user authentication based on comparison of an input authentication mode and a pre-registered authentication mode set by the user.

At block 315, upon successful verification of the user, the method (300B) includes signing, by the authentication system (104), one or more transaction elements associated with the second payment transaction request using a key pair (210) linked with the pre-registered authentication mode.

At block 317, upon successful signing using the linked key pair, the method (300B) includes executing, by the authentication system (104), the second payment transaction request.

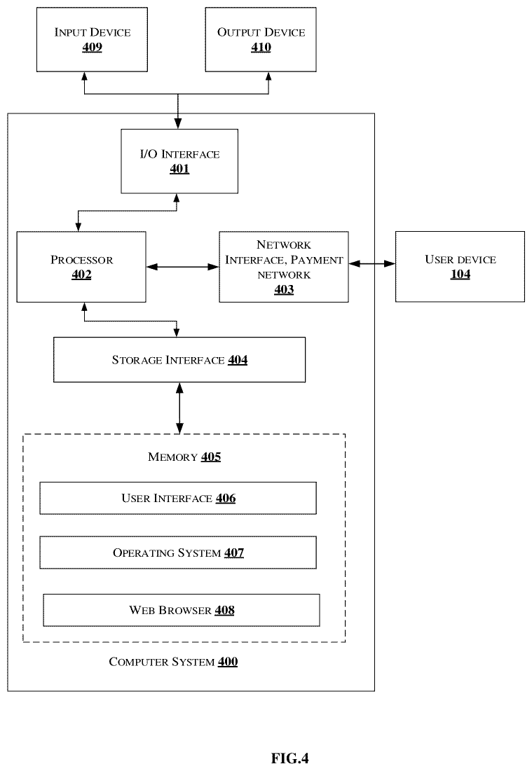

FIG. 4 illustrates a block diagram of an exemplary computer system (400) for implementing embodiments or aspects consistent with the present disclosure. Thus, the computer system (400) may be used to receive a first payment transaction request from a user device (102). The computer system (400) may comprise a Central Processing Unit (402) (also referred as “CPU” or “processor”). The processor (402) may comprise at least one data processor. The processor (402) may include specialized processing units such as integrated system (bus) controllers, memory management control units, floating point units, graphics processing units, digital signal processing units, etc. The processor (402) may be used to realize the processor (201) described in FIG. 2. In some non-limiting embodiments, processor (402) may be implemented in hardware, firmware, or a combination of hardware and software.

The processor (402) may be disposed in communication with one or more input/output (I/O) devices (not shown) via I/O interface (401). The I/O interface (401) may employ communication protocols/methods such as, without limitation, audio, analog, digital, monoaural, RCA, stereo, IEEE (Institute of Electrical and Electronics Engineers) 1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (401), the computer system (400) may communicate with one or more I/O devices. For example, the input device (409) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (410) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor (402) may be disposed in communication with the communication network via a network interface (403). The network interface (403) may communicate with the communication network. The network interface (403) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface (403) may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network includes, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some non-limiting embodiments or aspects, the processor (402) may be disposed in communication with a memory (405) (e.g., RAM, ROM, etc. not shown in FIG. 4) via a storage interface (404). The storage interface (404) may connect to memory (405) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (405) may store a collection of program or database components, including, without limitation, user interface (406), an operating system (407), web browser (408) etc. In some non-limiting embodiments or aspects, the computer system (400) may store user/application data, such as, the data, variables, records, etc., as described in this disclosure. Such databases may be implemented as fault-tolerant, relational, scalable, secure databases such as Oracle ® or Sybase®. The memory (405) may be used to realize the memory (203) described in FIG. 4. The memory (405) may be communicatively coupled to the processor (402). The memory (405) stores instructions, executable by the one or more processors (402), which, on execution, may cause the processor (402) performing the network authentication using device level authentication controls.

The operating system (407) may facilitate resource management and operation of the computer system (400). Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some non-limiting embodiments or aspects, the computer system (400) may implement the web browser (408) stored program component. The web browser (408) may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers (408) may utilize facilities such as AJAX™, DHTML™, ADOBE® FLASH™, JAVASCRIPT™, JAVA™, Application Programming Interfaces (APIs), etc. In some non-limiting embodiments or aspects, the computer system (400) may implement a mail server (not shown in Figure) stored program component. The mail server may be an Internet mail server such as Microsoft Exchange, or the like. The mail server may utilize facilities such as ASP™, ACTIVEX™, ANSI™ C++/C #, MICROSOFT®, .NET™, CGI SCRIPTS™ JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some non-limiting embodiments or aspects, the computer system (400) may implement a mail client stored program component. The mail client (not shown in Figure) may be a mail viewing application, such as APPLER MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments or aspects consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments or aspects described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The present disclosure may be configured to utilize device authentication data as a part of network authentication risk checks and the associated cryptographic techniques that are utilized as a part of device integrity determination, leading to providing a more secure way of completing a transaction. This secure way of transaction as disclosed in the method ensures and checks if the registered user is performing the network authentication or not, resulting in providing a secured transaction for the user during such network authentication using device level authentication controls. As an additional advantage, the present disclosure may provide enhanced secure way of authenticating several users utilizing the network authentication using device level authentication controls without compromising on any user details due to utilization of the network authentication risk checks in the device level authentication controls. Furthermore, the present disclosure is able to provide enhanced convenience to the users by providing an easy way of completing the transactions based on the on the go device level authentication controls resulting in faster completion of transaction when compared to conventional solutions.

In light of the technical advancements provided by the disclosed method and the control module, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “including”, “comprising”, “having” and variations thereof mean “including but not limited to”, unless expressly specified otherwise. The terms “a”, “an” and “the” mean “one or more”, unless expressly specified otherwise. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

A description of an embodiment with several components in communication with each other does not imply that all such components are required. On the contrary, a variety of optional components are described to illustrate the wide variety of possible embodiments or aspects of the disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other non-limiting embodiments or aspects of disclosure need not include the device itself.

Finally, the language used in the specification has been principally selected for readability and instructional purposes, and it may not have been selected to delineate or circumscribe the inventive subject matter. It is, therefore, intended that the scope of the disclosure be limited not by this detailed description, but rather by any claims that issue on an application based here on. Accordingly, the embodiments or aspects of the present disclosure are intended to be illustrative, but not limiting, of the scope of the disclosure, which is set forth in the following claims.

Although embodiments or aspects have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method comprising:
receiving, by an authentication system, a first payment transaction request from a user device, wherein the first payment transaction request includes a consent to register a user of the user device to authenticate based on an authentication mode selected by the user;
in response to receiving the consent, enabling the authentication mode, by the authentication system, for the user to perform an authentication using the selected authentication mode;
upon successful authentication, generating, by the authentication system, a key pair for linking with the enabled authentication mode for further authentication of the user device in one or more further transaction requests;
generating, by the authentication system, an enrolment completion message enabling the user device to be authenticated in the one or more further transaction requests using the enrolled authentication mode; and
executing, by the authentication system, the first payment transaction request upon successful signing using the linked key pair.

2. The method of claim 1, wherein the enabled authentication mode is one of a first plurality of registered authentication modes enrolled by the user, wherein the first plurality of registered authentication modes are associated with device level authentication controls.

3. The method of claim 1, wherein the key pair comprises a private key and a public key, wherein the private key is used for signing one or more transactions originating from the user device and stored in the user device, wherein the public key is used for validating the signed transactions originating from the user device and stored in the authentication system.

4. The method of claim 1, wherein executing the first payment transaction request comprising:
determining device integrity of the user device;
accessing the key pair in response to successful device integrity determination of the user device; and
validating the first payment transaction request to proceed with payment of the first payment transaction request.

5. The method of claim 1, comprising storing in a database, the authentication mode registered by the user, the authentication mode selected by the user, success or failure of device authentication, and timestamp associated with the success or failure of the device authentication.

6. The method of claim 1, comprising:
determining as to whether the user device is associated with device level authentication controls; and
enrolling one of a second plurality of authentication modes to authenticate the one or more further transaction requests, in response to determination that the user device is not associated with the device level authentication controls.

7. A method comprising:
receiving, by an authentication system, a second payment transaction request from a user device and an authentication mode as an input from a user;
verifying, by the authentication system, user authentication based on comparison of an input authentication mode and a pre-registered authentication mode set by the user;
upon successful verification of the user, signing, by the authentication system, one or more transaction elements associated with the second payment transaction request using a key pair linked with the pre-registered authentication mode; and
executing, by the authentication system, the second payment transaction request upon successful signing using the linked key pair.

8. The method of claim 7, wherein the key pair is accessed in response to successful device integrity determination of the user device.

9. The method of claim 7, wherein execution of the second payment transaction request comprises:
determining integrity of the user device; and
storing in a database, user device authentication data including the authentication mode pre-registered by the user, the authentication mode selected by the user, success or failure of device authentication, and timestamp associated with the success or failure of the device authentication.

10. The method of claim 9, wherein for determining the integrity of the user device the method further comprises determining one or more risks associated with the user device based on stored user device authentication data in the database.

11. An authentication system comprising:
a processor;
a memory, communicatively coupled to the processor, wherein the memory stores instructions, which, on execution, cause the processor to:
receive a first payment transaction request from a user device, wherein the first payment transaction request includes a consent to register a user of the user device to authenticate based on an authentication mode selected by the user;
in response to receiving the consent, enable the authentication mode for the user to perform an authentication using the selected authentication mode;
upon successful authentication generate a key pair for linking with the enabled authentication mode for further authentication of the user device in one or more further transaction requests;
generate an enrolment completion message enabling the user device to be authenticated in the one or more further transaction requests using the enrolled authentication mode; and
execute the first payment transaction request upon successful signing using the linked key pair.

12. The authentication system of claim 11, wherein the enabled authentication mode is one of a first plurality of registered authentication modes enrolled by the user, wherein the first plurality of registered authentication modes are associated with device level authentication controls.

13. The authentication system of claim 11, wherein the key pair comprises a private key and a public key, wherein the private key is used for signing one or more transactions originating from the user device and stored in the user device, wherein the public key is used for validating the signed transactions originating from the user device and stored in the authentication system.

14. The authentication system of claim 11, wherein for executing the first payment transaction request the processor is configured to:
determine device integrity of the user device;
access the key pair in response to successful device integrity determination of the user device; and
validate the first payment transaction request to proceed with payment of the first payment transaction request.

15. The authentication system of claim 11, wherein the processor is configured to store in a database, the authentication mode registered by the user, the authentication mode selected by the user, success or failure of device authentication, and timestamp associated with the success or failure of the device authentication.

16. The authentication system of claim 11, wherein the processor is configured to:
determine as to whether the user device is associated with device level authentication controls; and
enroll one of a second plurality of authentication modes to authenticate the one or more further transaction requests, in response to determination that the user device is not associated with the device level authentication controls.

17. An authentication system comprising:
a processor;
a memory, communicatively coupled to the processor, wherein the memory stores instructions, which, on execution, cause the processor to:
receive a second payment transaction request from a user device and an authentication mode as an input from a user;
verify user authentication based on comparison of an input authentication mode and a pre-registered authentication mode set by the user;
upon successful verification of the user, sign one or more transaction elements associated with the second payment transaction request using a key pair linked with the pre-registered authentication mode; and
execute the second payment transaction request upon successful signing using the linked key pair.

18. The authentication system of claim 17, wherein the key pair is accessed in response to successful device integrity determination of the user device.

19. The authentication system of claim 17, wherein for execution of the second payment transaction request the processor is configured to:
determine integrity of the user device; and
store in a database, user device authentication data including the authentication mode pre-registered by the user, the authentication mode selected by the user, success or failure of device authentication, and timestamp associated with the success or failure of the device authentication.

20. The authentication system of claim 19, wherein for determining the integrity of the user device the processor is further configured to determine one or more risks associated with the user device based on stored user device authentication data in the database.
